(19) United States
(12) Patent Application Publication
(10) Pub. No.: US 2009/0084044 A1
(43) Pub. Date: Apr. 2, 2009

(54) CONFORMABLE SILL MEMBRANE

(75) Inventor: John R. HOPKINS, Bow Mar, CO (US)

Correspondence Address: MARSH, FISCHMANN & BREYFOGLE LLP, 8055 East Tufts Avenue, Suite 450, Denver, CO, 80237, US

(73) Assignee: PROTECTO WRAP COMPANY, Denver, CO (US)

(21) Appl. No.: 11/761,902

(22) Filed: Jun. 12, 2007

Related U.S. Application Data
(63) Continuation-in-part of application No. 11/426,246, filed on Jun. 23, 2006.

(51) Int. Cl. E06B 7/14; E04B 1/66

(52) U.S. Cl. 52/58; 52/741.4

(57) ABSTRACT

Disclosed herein are various waterproof membranes that may be applied to a sill surface of an opening in a building structure to waterproof that surface as well as direct water that penetrates through the opening out of the structure. Generally, one or more flexible waterproof membranes are adhesively applied to the sill surface for purposes of waterproofing that surface. In one arrangement, an exposed top surface of the membrane forms a resilient surface that allows for inserting, for example, shims between the membrane and a structure disposed on the membrane without damaging the membrane. In another arrangement, an exposed top surface of the membrane includes a wicking material to facilitate removal of moisture from a structure. In another arrangement, the membrane includes a conformable flap to facilitate the adherence of the flap to surface that is transverse to the remainder of the membrane.

### CROSS REFERENCE TO RELATED APPLICATION

This application is a continuation-in-part of U.S. application Ser. No. 11/426,246 entitled “Flexible Wicking Membrane” having a filing date of Jun. 23, 2006, the entire contents of which are incorporated by reference herein.

### FIELD

The present invention generally relates to building products and, more particularly, pertains to an impermeable membrane that having a first portion that is adapted for application to a sill surface and a second portion that is conformable to a transverse surface for adherence thereto.

### BACKGROUND

One of the most common failure points for unwanted air and/or moisture in a building envelope is around doors and windows. Controlling air and/or moisture is a serious concern, which may result in exterior and interior damage if not prevented or corrected in a timely manner. In addition, heat losses caused by air leakage around building openings have taken on new significance due to today's high-energy costs. Sealing such openings has typically been accomplished by caulking or using putty-like compound around openings between door and window frames to seal the gaps and prevent inward seepage of air and/or water into the building.

In window installations, caulking around the window has been the known installation and application method. However, over several years, such caulking typically cracks, as it cannot withstand the constant expansion and contraction of the window. Some studies indicate that after several years in operation, a majority of all windows will leak through the window flange or the window itself. The same is often true for doors. This water leakage can lead to structural damage such as rotting of sill surfaces and mold.

Given these problems, there remains a need for an improved method for waterproofing internal components of an opening of a structure and for removing moisture that penetrates into the opening.

### SUMMARY

In view of the difficulties in waterproofing openings into building structures, such as door and window openings, provided herein are systems and methods (i.e., utilities) for use in waterproofing sill surfaces of such openings and/or removing water that penetrates into such an opening. Generally, the utilities discussed herein utilize one or more flexible membranes that are applied to the sill surface for purposes of waterproofing that surface. Such membranes may incorporate an adhesive surface for adhering a first portion of the membrane to the sill surface and a second portion of the membrane to an outside surface of a building structure. Such membranes may further incorporate a dam/back dam disposed proximate to the rearward edge of a sill plate (i.e., disposed toward the interior of the structure) to direct water towards the front edge of the sill plate (i.e., toward the outside of the structure). Further, such membranes may include wicking material on one or more surfaces to allow for directing water out of a building structure.

In a first aspect, a membrane is provided that is operative to direct water away from a surface on which the membrane is applied. Such a membrane may further be utilized to create a sill pan for an opening within a structure. The membrane includes a flexible waterproof sheet having a top surface and a bottom surface wherein a wicking material is attached to at least a first portion of the top surface. A second portion of the top surface may form an adhesive surface that may be covered by a release sheet. Such a release sheet is releasably attached to the adhesive such that the release sheet may be removed to expose the adhesive surface, which may be contacted with and adhered to a desired structure.

In one arrangement, the flexible waterproof sheet member and the adhesive surface thereon may be integrally formed. For instance, the sheet member may be formed of a bitumen containing material or rubberized material. In such an arrangement, the bitumen or rubberized material, or other material providing waterproofing and adhesive qualities, may be formed into a sheet-like member. Accordingly, this may permit attaching the wicking material directly to the surface of the sheet member without additional adhesives. In another arrangement, the sheet material may not include adhesive qualities. In such an arrangement, an adhesive may be applied to the top surface of the sheet member to attach the wicking material and/or to provide an adhesive surface for contacting with additional structures.

In another arrangement, at least a portion of the bottom surface of the sheet member is an adhesive surface. Again, an adhesive may be applied to the bottom surface or may be integrally formed with the sheet member. Likewise, a release sheet may be releasably attached to the bottom adhesive surface. In a further arrangement, a first portion of the bottom surface comprises an adhesive surface, and a second portion of the bottom surface is formed as a non-adhesive surface. In one particular arrangement, a portion of the surface that forms a non-adhesive surface corresponds at least in part to an adhesive top surface portion of the membrane.

According to another aspect, a utility is provided for forming a sill pan on a sill surface in an opening of a building structure. The utility includes disposing a flexible membrane across the length of a generally horizontal sill surface. Such a sill surface is typically disposed between first and second upright members (e.g., studs). In addition to being disposed across the length of the sill surface, the flexible membrane may, but not necessarily, include a first end that extends at least partially up a first upright member and a second end that extends at least partially up the second upright member. A rearward edge of the membrane (e.g. disposed towards the inside of the structure) that is disposed between the first and second uprights may be folded transverse to the generally horizontal sill surface. This resulting transverse portion of the membrane forms a barrier or back dam between the first and second uprights. This back dam prevents water on the sill from infiltrating into the building structure.

In cases where end portions of the membrane extend partially up the uprights, the interface between the back dam and the portions of the membrane that extend partially up the upright members may form a watertight corner. For instance, a dog-ear fold may be made at an angle between the upright member and the transverse back darn. The resulting ear may be folded against one of the uprights and the back dam.

Of note, if the back dam is formed from the flexible membrane, it may require support along its length to maintain its transverse position relative to the horizontal sill surface. Accordingly, the back dam may be secured to a window or door that is disposed over the membrane across the sill surface. In one arrangement, such securing may entail removing a release sheet from at least a portion of the back dam to thereby expose an adhesive surface. This adhesive surface may then be contacted to the door or window placed on the sill surface.

Forming the sill pan may further entail removing a release sheet from at least a portion of the bottom surface of the flexible membrane to expose a bottom adhesive surface. This bottom adhesive surface may be contacted to at least a portion of the sill surface. Further, end portions of the bottom surface may be contacted to the first and second upright members. In such an arrangement, the flexible membrane may be adhered to the sill surface and upright members.

In further arrangement, a top surface of the membrane may include a wicking material that is adapted for directing water away from the back dam and out of the building structure. In such an arrangement, the wicking material may extend over a top surface of the membrane from, for example, the back darn to a front edge of the membrane, which may extend over a front edge of the opening. Accordingly, the membrane may be adhered to a surface transverse to the sill surface. For instance, the front edge of the membrane may be adhered to an outside surface of the building structure. The wicking material may then be operative to wick material from within the building structure to a location outside of the building structure.

In a further arrangement, a spacer material may be disposed across the length of the sill surface between the first and second upright members in order to provide higher elevation at the rearward edge of the sill and thereby provide a positive slope to drain water to the front of the sill and out of the building structure. Accordingly, a membrane may be disposed in front of and/or over the spacer material. This may improve water flow out of the structure. The spacer material may be any material that maintains a rearward portion of the membrane elevated. Such material may include, without limitation, flexible materials, (e.g., closed or open cell foams, plastics, etc.) as well as rigid materials.

In another aspect, a membrane is provided that provides a durable surface portion for disposition on a sill surface of an opening within a structure while providing a highly conformable portion for connection to a transverse outside surface of the opening. In this regard, a first portion of the membrane may, be adhered to a first surface (e.g., a generally horizontal surface) and the second portion may be adhered to a second surface (e.g., a generally vertical surface). Thus, the membrane may seal an interface between these surfaces. It may be desirable that the portion of the membrane that is disposed on the horizontal surf-ace (e.g., sill surf-ace) provide a durable exposed surface. This may allow, for example, inserting shims between a window/door and the membrane without puncturing the membrane. That is, as the horizontal surface may support a door or window, it may be beneficial to provide an exposed membrane surface that is resistant to puncture. To facilitate the adherence of the second portion of the membrane to the second transverse surface, it may be desirable for the second portion of the membrane to be highly conformable. In this regard, the highly conformable second portion of the membrane may fold over the interface between the surfaces to provide a sealed transition between the surfaces, which may facilitate the removal of moisture from the horizontal surface to outside of the structure. Such membranes may further include a spacer/back dam disposed proximate to the rearward edge of a sill surface (i.e., disposed toward the interior of the structure) to direct water towards the front edge of the sill surface (i.e., toward the outside of the structure). Such a back dam may be applied to the sill surface or be attached to the membrane. Further, such membranes may include wicking material on one or more surfaces to allow for directing water out of a building structure.

In a first arrangement, the membrane includes a flexible waterproof sheet having a top surface and a bottom surface wherein a non-adhesive facer material is attached to a first portion of the top surface. A second portion of the top surface of the membrane is free of the facer material. In this regard, the second portion of the membrane is more pliable than the first portion. All or a portion of a bottom surface of the membrane is an adhesive surface that may be covered by one or more release sheets.

Generally, the portion of the membrane covered by the non-adhesive facer material may be disposed on a horizontal surface while the second portion of the membrane may extend beyond the sill surface. That is, the second portion may form a flap that may be conformed to an outside surface or an opening. In this regard, it may be desirable that the flap be highly flexible and/or elastic. To have such flexibility, it may be desirable, but not necessary, that at least the flap of the membrane contain little or no internal reinforcement. In such an arrangement, membranes formed of a bituminous material or a butyl rubber compound may be utilized. However, it will be appreciated that other materials that provide flexibility, adherence and/or waterproofing properties may be utilized.

According to another arrangement, a utility is provided for forming a sill pan on a sill surface in an opening of a building structure. The utility includes disposing a flexible membrane across the length of a generally horizontal sill surface. Such a sill surface is typically disposed between first and second upright members (e.g., studs). In addition to being disposed across the length of the sill surface, the flexible membrane may, but not necessarily, include a first end that extends at least partially up a first upright member and a second end that extends at least partially up the second upright member. A forward edge of the membrane (e.g., disposed towards the outside of the structure) that is disposed between the first and second uprights may be folded transverse to the generally horizontal sill surface. This resulting transverse portion of the membrane forms a flap that extends over, for example, exterior sheathing between the first and second uprights. This flap provides a continuous path for water on the sill to exit the building structure.

Forming the sill pan may further entail removing a release sheet from at least a portion of the bottom surface of the flexible membrane to expose a bottom adhesive surface. This bottom adhesive surface may be contacted to at least a portion of the sill surface. Further, end portions of the bottom surface may be contacted to the first and second upright members. In such an arrangement, the flexible membrane may be adhered to the sill surface and upright members.

In further arrangement, a first portion of the top surface of the membrane (e.g., disposed on the sill surface) may include a durable non-adhesive surface. In such an arrangement, the non-adhesive surface material may extend over a top surface of the membrane from, for example, a back edge to an edge of the sill surface disposed proximate to an outside edge of an opening. The second portion of the top surface of the of the membrane may be free of the non-adhesive material. This second portion may extend over a front edge of the opening. Accordingly, the second portion of the membrane may be adhered to a surface transverse to the sill surface. For instance, the front edge of the membrane may be adhered to an outside surface of the building structure. Such adherence may entail the removal of a release sheet(s) from the bottom and/or top surface of the second portion of the membrane.

In one arrangement, a spacer material may be disposed across the length of the sill surface between the first and second upright members in order to provide higher elevation at the rearward edge of the sill and thereby provide a positive slope to drain water to the front of the sill and out of the building structure. That is, a back dam may be provided to improve water flow out of the structure. Accordingly, the membrane may be adhered over or in front of the back dam to improve flow of moisture outside of a structure.

### BRIEF DESCRIPTION OF THE DRAWINGS

FIG. 1 is a perspective view of one embodiment of a conform able membrane.

FIG. 2A is a cross sectional view of the membrane of FIG. 1.

FIG. 2B is a cross sectional view of an alternate embodiment of the membrane of FIG. 1.

FIGS. 3A and 3B are perspective views of the membrane of FIG. 1 being applied within a window opening.

FIG. 4 is a perspective view of one embodiment of a wicking membrane.

FIG. 5 is a perspective view of another embodiment of a wicking membrane.

FIGS. 6A-6C illustrate forming the membrane of FIG. 4 into a sill pan.

FIG. 7 illustrates a first step for applying the membrane of FIG. 4 within a window opening.

FIG. 8 illustrates a second step for applying the membrane of FIG. 4 within a window opening.

FIG. 9 illustrates applying a window over the membrane of FIG. 8.

### DETAILED DESCRIPTION

Reference will now be made to the accompanying drawings, which at least assist in illustrating the various pertinent features of the present invention. In this regard, the following description that utilizes a flexible membrane to form a sill pan in a window opening is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. It will be appreciated that various aspects of the invention have utility for applications other than forming sill pans for windows and doors, for example, applications where it is desirable to remove moisture from a structure. The embodiments described herein are further intended to explain the best modes known of practicing the invention and to enable others skilled in the art to utilize the invention in such, or other embodiments and with various modifications required by the particular application(s) or use(s) of the present invention.

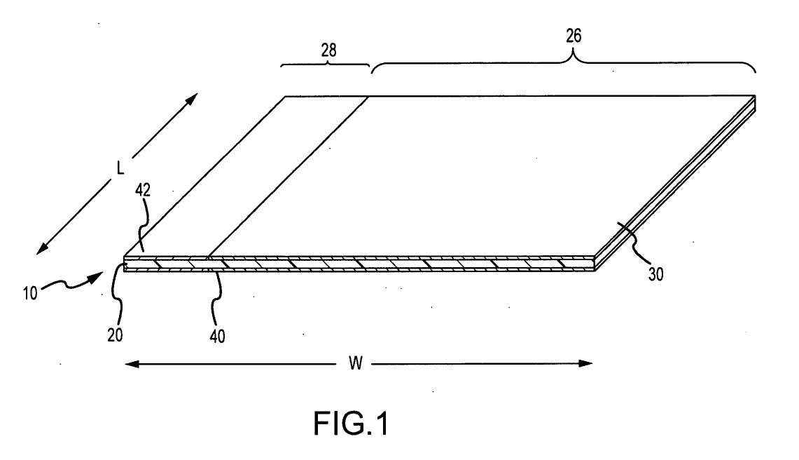

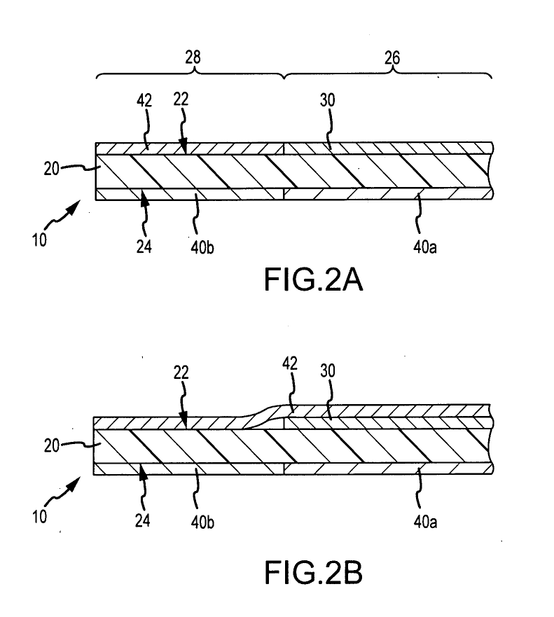

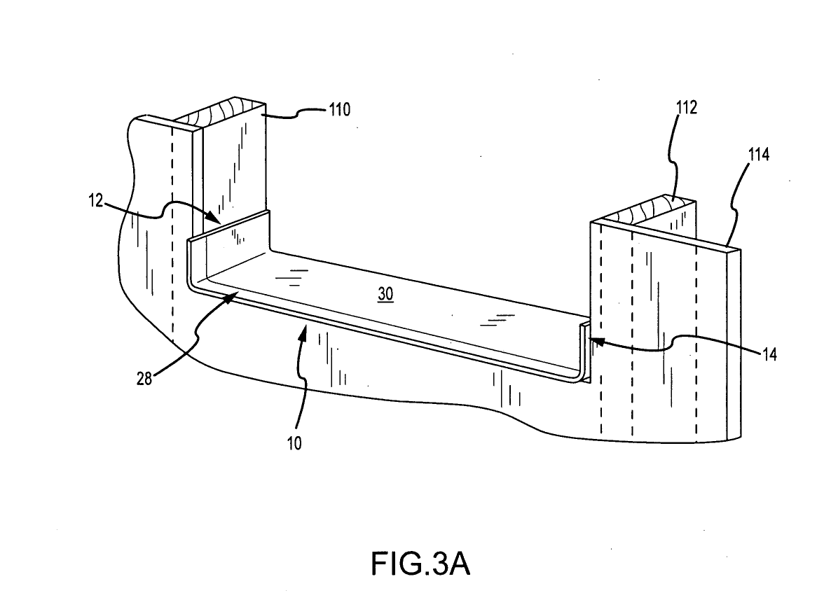

FIGS. 1 and 2A illustrate perspective and cross sectional views, respectively, of one embodiment of a conformable membrane 10 in accordance with certain aspects of the present invention. Generally, the membrane 10 is adapted for adhesive interconnection to a surface such that it may provide waterproofing qualities to the surface. Stated otherwise, the membrane provides a substantially impermeable barrier that may be applied to a surface to prevent moisture from contacting that surface. To further enhance the durability of the membrane, the membrane 10 includes a facer material 30 that is attached to at least a portion of a top surface of the membrane 10.

In the present embodiment, the membrane 10 is formed using an adhesive sheet member 20 having first and second opposing surfaces. For purposes of the discussion, the opposing surfaces are referred to as the top surface 22 and bottom surface 24. However, it will be appreciated that other naming conventions may be utilized. The construction of the adhesive sheet member of 20 may be varied. For instance, the adhesive sheet member 20 may be formed from any flexible sheet-like material that provides the desired level of impermeability. For instance, the sheet member 20 may be formed from a plastic sheet and have an adhesive applied to one or both of the top and bottom surfaces 22, 24. In an alternate arrangement, the adhesive sheet member 20 may be formed of a material that provides both waterproofing properties (e.g., impermeability) as well as adhesive properties. Additionally, the sheet member 20 may itself be a multilayered structure. For instance, the sheet member 20 may be constructed having one or more reinforcing layers (e.g., mesh layers), base sheet layers (e.g., plastic sheet layers) and/or various adhesive layers (e.g., bitumen-containing layers).

Non-limiting examples of suitable materials for use in producing an adhesive sheet member having both adhesive and waterproofing properties include bitumen-containing materials such as various tar adhesives and rubberized asphalts, as well as natural and/or synthetic rubber (e.g., butyl-rubber) and butyl-rubber compounds. For instance, the adhesive sheet member 20 may be at least partially constructed from a modified, rubberized asphalt material. In another arrangement, the adhesive sheet member may be formed from butyl rubber. However, it will be appreciated that numerous other natural and synthetic materials may also be utilized to create an integrally formed adhesive sheet member having both adhesive and waterproof qualities.

The use of the integrally formed adhesive sheet member 20 allows for conveniently interconnecting the facer material 30 to the top surface 22 of the sheet member 20. In this regard, the facer material 30 may also be formed in a sheet and may be applied to an exposed surface of the sheet member 20 in order to adhere the facer member to that surface. Such application may be performed utilizing compressive rollers in a manner similar to that disclosed in U.S. Pat. No. 6,676,779 entitled “Air and moisture barrier laminate apparatus” the entire contents of which are incorporated herein by reference.

The facer material 30 may be any material that forms a durable non-adhesive surface. For instance, the facer material 30 may be formed from a sheet of plastic that is adhered to a first portion 26 of the top surface 22 of the sheet number 20. This may allow the bottom surface of the first portion 26 of the membrane 10 to be adhered to a surface in a first plane while the bottom surface of a second portion 28 of the membrane 10, which may be free of facer material, is adhered to a surface in a second transverse plane. However, it will be appreciated that numerous other materials may also be utilized to form the facer.

In order to attach the membrane 10 to a sill surface and an outside surface of a building structure, the bottom surface 24 of the sheet member 20 may be adapted for adhesive interconnection to a contacting surface. For instance, the membrane 10 may incorporate a release sheet 40 that is removably interconnected to the bottom surface 24 of the membrane 10. Alternatively, first and second release sheets 40a and 40b may be connected to first and second portions 26, 28 of the bottom surface 24 of the membrane 10. In this regard, the release sheets 40 may be removed from the bottom surface 24 such that adhesive associated with the bottom surface 24 may be contacted with a surface for which waterproofing is desired. Many different foils, films, papers or other sheet materials are suitable for use in constructing the release sheet 40. For example, the release sheet 40 may be formed from metals, plastics, or papers treated with silicon or other substances to provide a low level of adhesion to the underlying adhesive associated with the sheet member 20. In any ease, it is desirable that the release sheet 40 be easily removable from the adhesive sheet 20.

In the embodiment illustrated in FIG. 1, the facer material 30 covers a first portion 26 of less than the entire top surface 22 of the sheet member 20. A remaining second portion 28 of the top surface 24 forms a conformable flap for adhering the membrane 10 to an outside surface of a structure. The top surface of the second portion may be covered by a release sheet 42. Further, the release sheet may extend over the entirety of the top surface. See FIG. 2-2B. As shown in FIG. 1, the second portion 28 is formed as a strip along the length of the membrane 10. It should be noted that the membrane 10 may have any appropriate shape based on the requirements of a particular application. However, when utilized to create a window or door sill membrane or pan, as discussed herein, it may be desirable that the membrane 10 be formed as a elongated strip (e.g., a rectangular strip) having a length L that is typically longer than its width W. In such an arrangement, the first portion 26 and second portion 28 of the top surface 22 may be defined across the width of the membrane 10 such that each portion 26, 28 forms a strip along the length of the membrane 10.

As noted, the second portion 26 forms a flap of the membrane 10 that may be folded relative to the first portion. In this regard, it may be desirable that the flap be highly flexible and/or elastic. To have such flexibility, it may be desirable that at least the flap of the membrane contain little or no internal reinforcement.

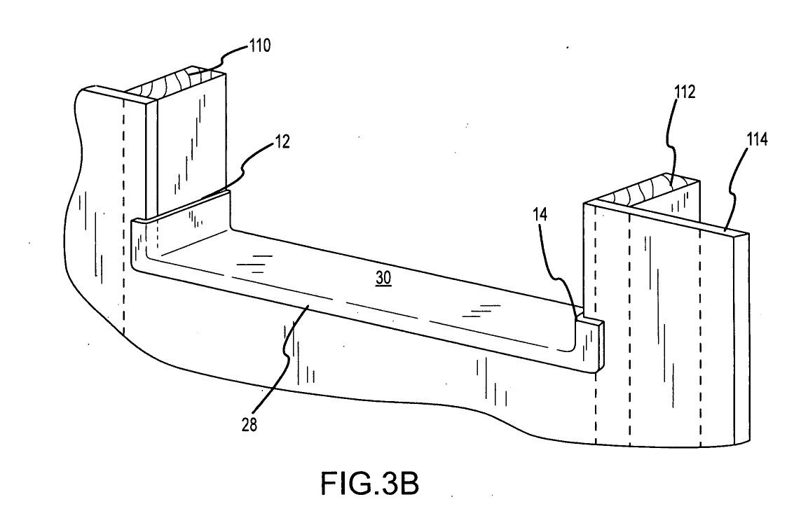

Once appropriately sized, the bottom surface of the membrane 10 may be adhered to the sill surface of a window opening of the windowsill. See FIG. 3A. In this regard, the release sheet(s) may be removed from the bottom surface 24 of the membrane 110. (Not shown) An installer then adhesively secures the membrane 10 across entire length of the windowsill. In the present embodiment, first and second ends 12, 14 of the membrane 10 extend partially up first and second upright members or studs 110, 112. Preferably, the width of the membrane 10 is such that the portion covered by the facer material 30 is disposed on the sill surface while the second portion 28, free of the facer material, extends beyond the front edge of the sheathing material 114 to form a flap. After the membrane 10 is adhered to the windowsill, the installer may fold the flap (e.g., the second portion 28) of the membrane 10 that extends beyond the sheathing material 114 downwardly and adhesively secure this portion to the front surface of the sheathing material 114 as seen in FIG. 3B. When installing the membrane 10, it should be appreciated that the elasticity of the flap0, which is free of reinforcing materials, readily allows an installer to pull and position the portion of the membrane 10 that extends beyond the sill onto the sheathing material 114 or other outside surface as desired.

At this point, the membrane 10 is fully installed and the facer material 30 disposed on the top surface of the membrane 10 may extend from the back edge of the windowsill across the width of the windowsill to provide a durable surface for supporting a component such as a door or window and/or allowing shimming between the membrane i.e., sill surface) and the door/window. Likewise, the flap may extend downwardly onto the outside surface of the sheathing material 114. As will be appreciated, this may allow directing water from within the envelope of a building to an outside surface of the building. Specifically, as the facer material 30 repels water and may be sloped downward, the flap directs water to the outside surface of the sheathing material 114. The impermeability of the membrane 10 prevents water from contacting the generally wooden windowsill while the downwardly extending flap directs water outside of the structure. This combination may prevent structural damage of the windowsill and lessen the likelihood of mold forming within the walls of a completed structure.

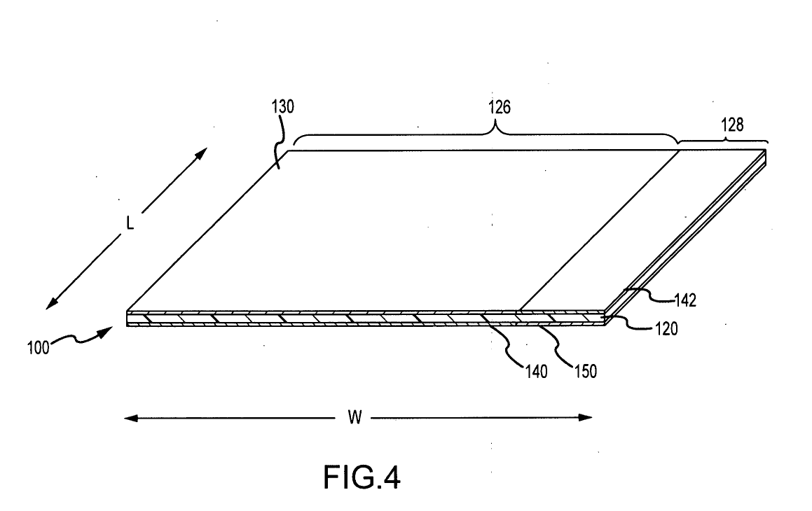

FIG. 4 illustrates a perspective view of one embodiment of a wicking membrane 100 in accordance with certain aspects of the present invention. Generally, the membrane 100 is adapted for adhesive interconnection to a surface such that it may provide waterproofing qualities to the surface. Stated otherwise, the membrane provides a substantially impermeable barrier that may be applied to a surface to prevent moisture from contacting that surface. To further enhance the waterproofing qualities of the membrane, the membrane 100 includes a wicking material 130 that is attached to at least a portion of a first surface of the membrane 100. The wicking material 130 is adapted to move water from a first location on the membrane to a second location using capillary action. As may be appreciated, the wicking material 130 may be operative to move moisture out of the building envelope of a structure, as will be more fully discussed herein.

In the present embodiment, the membrane 100 is formed of an adhesive sheet member 120 having first and second opposing surfaces. For purposes of the discussion, the opposing surfaces are referred to as the top surface and bottom surface. However, it will be appreciated that other naming conventions may be utilized. The construction of the adhesive sheet member of 120 may be varied.

The use of the adhesive sheet member 120 allows for conveniently interconnecting the wicking material 130 to the top surface of the sheet member 120. In this regard, the wicking material 130 may also be formed in a sheet and may be applied to an exposed adhesive surface of the sheet member 120 in order to adhere the wicking member to that surface. The wicking material 130 may be any material that is operative to effect the movement of moisture utilizing capillary action. In one embodiment, the wicking material is formed from an industrial felt. However, it will be appreciated that numerous other natural and synthetic materials may also be utilized.

In order to attach the membrane 100 to a surface, the bottom surface of the adhesive sheet member 120 may be adapted for adhesive interconnection to a contacting surface. For instance, the membrane 100 may incorporate a bottom release sheet(s) 140 that is/are removably interconnected to the bottom surface of the membrane 100. In this regard, the release sheet(s) 140 may be removed from the bottom surface such that adhesive associated with the bottom surface may be contacted with a surface for which waterproofing is desired.

In the embodiment illustrated in FIG. 4, the wicking material 130 covers a first portion 126 of less than the entire top surface of the sheet member 120. A remaining second portion 128 of the top surface is adapted to adhere the membrane 100 to a transverse surface (e.g., to form a back dam). As shown, the second portion 120 is formed as a strip along the length of the membrane 100. The membrane 100 is generally formed as an, elongated strip (e.g., a rectangular strip) having a length that is typically larger than its width. In such an arrangement, the first portion 126, defined by the wicking material 130, and second portion 128, defined as an adhesive surface of the top surface may be defined across the width W of the membrane such that each portion forms a strip along the length L of the membrane.

To permit the second portion 128 of the top surface to be selectively attached to a surface, a second or top release sheet 142 may cover an adhesive surface associated with the second portion 128. Further, to allow the second portion 128 of the membrane 100 to be adhered to a surface that is transverse to the first portion of the membrane 100, the bottom surface beneath the second section 128 of the membrane may be formed from a non-adhesive backing member 150. For instance, the backing member 150 may be formed from a sheet of plastic that is permanently adhered to a portion of the bottom surface of the sheet member 120. This may allow the top surface of the second portion 128 of the membrane 100 to be adhered to a surface in a first plane while the bottom surface of the first portion 126 of the membrane 100 is adhered to a surface in a second transverse plane.

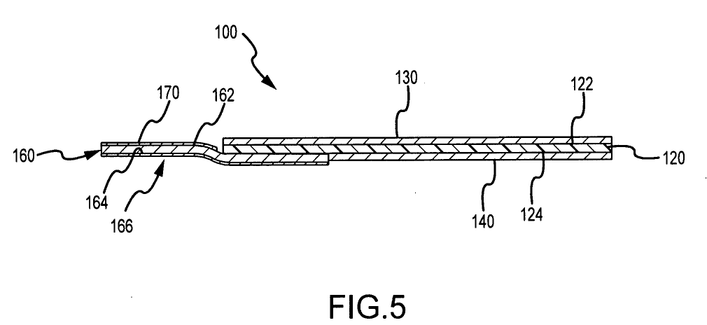

FIG. 5 illustrates another embodiment of a wicking membrane 100 where the membrane 100 is formed from first and second sheet members 120 and 160. The first sheet member 120 includes a top surface 122 to which a wicking material 130 is adhesively interconnected and a bottom surface 124 to which a release sheet 140 is releasably interconnected. As shown, the wicking material 130 extends across the entire top surface 122 of the first sheet member 120. In contrast, the release sheet 140 extends across only a portion of the bottom surface 124 of the first sheet member 120. As shown, the second sheet number 160 is adhesively interconnected to the first sheet member 120 on the portion of the bottom surface 124 that is not covered by the release sheet 140.

The second sheet number 160 includes an adhesive top surface 162 and a bottom surface 164. In the present embodiment, the bottom surface 164 is covered by a non-adhesive backing material 166 (e.g., a plastic sheet) to prevent the bottom surface 164 of the second sheet member 160 from adhering to a surface. A portion of the adhesive top surface 162 is adhered to the bottom surface 124 of the first sheet member 120. In this regard, the mating portions of the membranes may each be adhesive surface that are exposed and contacted together to interconnect the first and second sheet members 120, 160. The remaining portion of the adhesive top surface 162 of the second sheet member 160 is covered by a release sheet 170. This release sheet 170 may be selectively removed as will be discussed herein.

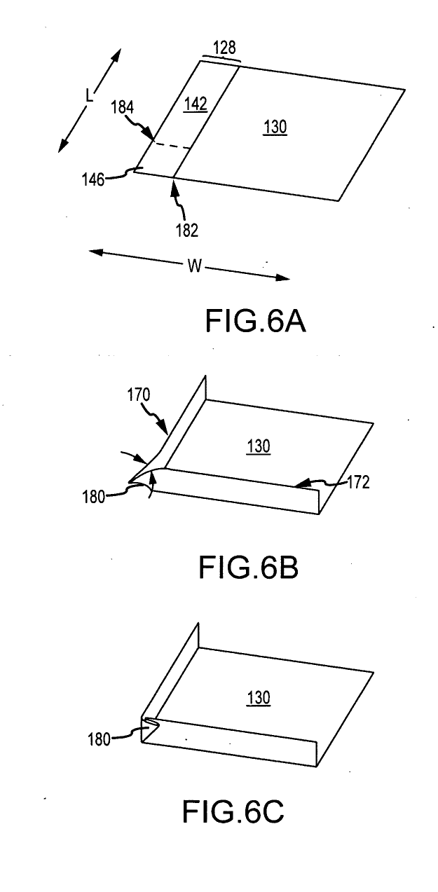

One application for the wicking membrane 130 is to form a still pan for use with a door or window. FIGS. 6A-6C illustrate a method for forming the generally flat membrane 100 into a sill pan that may be positioned along a sill surface beneath a window or door. Such a sill pan may provide waterproofing for the sill surface as well as provide a means for moving moisture/water that has infiltrated behind a door or window out of a building envelope.

As shown in FIGS. 6A-6C, a sill pan may be formed by creating a dog-ear fold in a corner of the membrane 100. For purposes of discussion, the formation of a sill pan is discussed in relation to the membrane embodiment of FIGS. 4 and 5; however, it will be appreciated that the sill pan may be formed from membranes similar to the membrane of FIGS. 1-3 as well. As shown in FIG. 6A, a portion of the top release sheet 142 may be removed from the top surface of the second portion 128 of the membrane 100 (i.e., the portion that is that is not covered by the wicking material 30) to expose an adhesive surface 146. Opposing points 182, 184 of the exposed adhesive surface may be moved into contact with one another to form an ear 180. As may be appreciated, the adhesive surface 146 may bond to itself when the opposing points 182, 184 are contacted. See FIG. 6B. In conjunction with forming the ear 180, the membrane 100 may be folded along its length and width to form an upstanding back dam 170 and an upstanding sidewall 172, respectively. The ear 180 may then be folded against one of the back dam 170 and the sidewall 172. See FIG. 6C. The same process may be repeated on an opposing end of the membrane 10 to form a sill ‘pan’ having an open front.

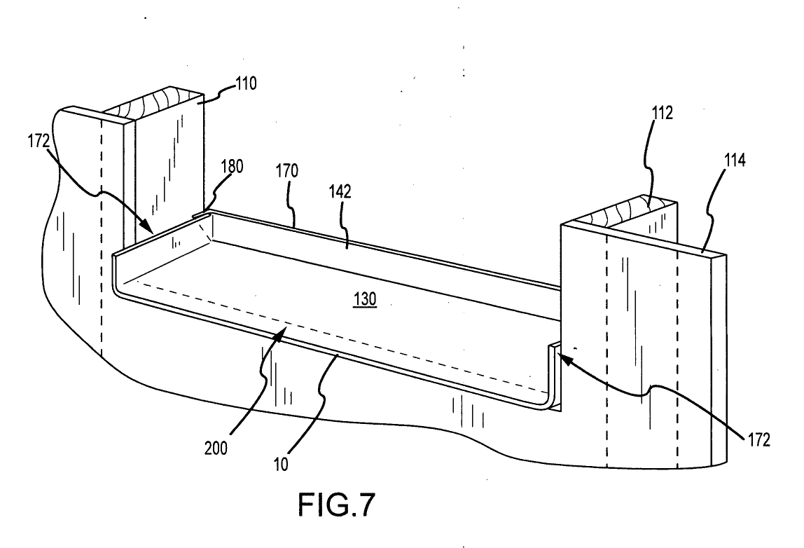

FIG. 7 illustrates such a sill pan 2300 formed from the flexible membrane 10 in a window opening. The window opening includes a bottom cross member or windowsill (i.e., disposed beneath the sill pan) that extends between first and second upright studs 110, 112. As may be appreciated, such a window opening would also include a top cross member (not shown) that would extend between the first and second studs 110, 12. The resulting four-sided framework would define a window opening that may be sized to receive a window frame. As shown, sheathing material 114 is applied across to the outside surfaces of the studs 110, 112 around the window opening.

The sill pan 200 may be formed prior to being positioned within the window opening or the sill pan 200 may be formed in place. In the latter regard, a first end of the membrane 100 may be positioned adjacent to one of the studs, for example, stud 110 and a dog-ear corner 180 may be formed. As shown, this may permit forming a sidewall 172 along the stud 110 and a back dam 170 that extends between studs 110, 112. An installer may tack or nail the folded ear 180 to the stud 110 to maintain the position of the sill pan 200 within window opening while the second end of the sill pan is formed adjacent to the other stud 112. As will be appreciated, the membrane 100 may come in any lengths and maybe cut to an appropriate length such that a second end of the membrane adjacent to stud 112 is of an appropriate length to form a second sidewall against the opposing stud 112. The back dam 170 and sidewalls 172 generally form a open fronted pan that is operative to receive any water that drains to the surf-ace of the window sill and direct that water outside the building structure, as will be discussed herein.

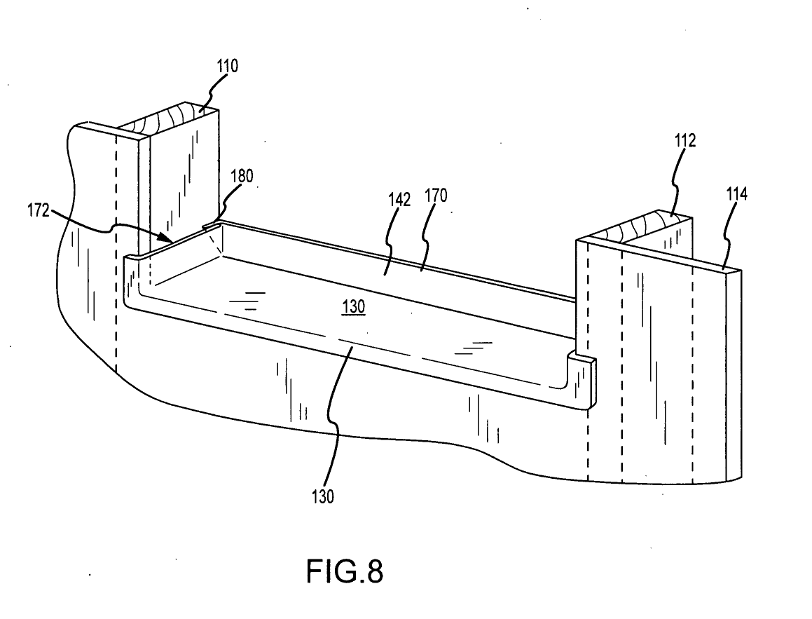

Once appropriately sized and formed, the bottom surface of the sill pan 200 may be adhered to the top of the windowsill. In this regard, the release sheet 40 may be removed from the bottom surface of the membrane 100. An installer then adhesively secures the membrane 100 across entire length of the windowsill. Preferably, the width of the resulting still pan 200 is such that it extends beyond the front edge of the sheathing material 114. After the still pan 200 is adhered to the windowsill, the installer may fold a portion of the membrane 10 that extends beyond the sheathing material 114 downwardly and adhesively secure this portion to the front surface of the sheathing material 114 as seen in FIG. 8.

At this point, the sill pan 200 is fully installed and the wicking material 130 disposed on the top surface of the membrane 100 may extend from the back edge of the windowsill (i.e., adjacent to the back dam 170) across the width of the windowsill and downwardly onto the outside surface of the sheathing material 114. As will be appreciated, this may allow directing water from within the envelope of a building to an outside surface of the building. Specifically, as the wicking material 130 on the outside surface of the sheathing material 114 is disposed below the wicking material 130 on the generally horizontal window sill, capillary action will draw water across the sill. Further, the wicking material may be operative draw water over the sill even when the windowsill is not perfectly level. That is, the capillary action of the wicking material 130 may allow for wicking moisture up and over the front edge of a windowsill and to the outside surface of the sheathing material 114. In any case, the wicking material 130 directs water which penetrates a window outside of the a building envelope.

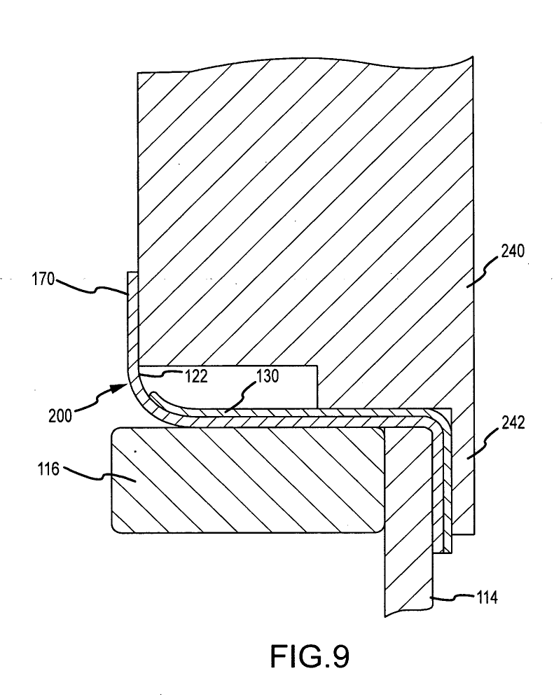

FIG. 9 illustrates a cross-sectional view of a window frame 240 being placed on to the sill pan 200. As shown, the window frame 740 is positioned in the window opening of the framework such that that a window frame flange 242 overlaps the outside surfaces of the sheathing material 114 around the perimeter of the window opening. A portion or all of the bottom of window frame 240 is positioned in contact with the top surface (i.e., wicking material 130) of the sill pan 200, which sets atop of the windowsill 116. Generally the window frame 240 is held in place by inserting mechanical fasteners through the window flange 242 into the framework. Accordingly, caulk may be applied to the inside surface of the flange 242 to improve the sealing. Importantly, it should be noted that even if caulk is applied to the inside surface of the window flange, the wicking material 130 will still provide a path for moisture evacuation. Further, it may be desirable to apply a sealing tape to overlap the window flange 242 and the sheathing material 114 about the perimeter of the window frame 240.

The adhesive surface of the back dam 170 may then be utilized to adhere the back dam 170 to the window frame 240. As may be appreciated, this may provide support for the generally flexible back dam 170 between the upright studs 110, 112. To adhere the front surface of the back dam to the window frame, the window may be properly positioned and the release sheet on the surface of the back dam 170 may be removed. An installer then adhesively secures the back dam across the length of the window frame 240. With this construction, moisture that leaks into the window through window flange 242 or the window itself can be wicked across the windowsill and out of the structure. Further, such moisture is prevented from penetrating the interior of a structure by the back dam 170. Alternatively, mechanical fasteners may be utilized to attach the back dam 170 to the window frame. Accordingly, the back dam 170 may not include an adhesive surface.

While the invention has been described with reference to a preferred embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

1.-21. (canceled)

22. A membrane for use in waterproofing a sill surface, comprising:
a flexible adhesive sheet member;
a bottom release sheet releasably attached to a bottom surface of the adhesive sheet member; and
a non-adhesive sheet member attached to a first portion of the sheet member on a top surface of the sheet member, wherein a second portion of the sheet member is free of the non-adhesive sheet member.

23. The membrane of claim 22, wherein the second portion of the sheet member has a greater pliability than the first portion that is covered by the non-adhesive sheet member.

24. The membrane of claim 22, further comprising:
a top release sheet releasably attached to at least the second portion the sheet member on the top surface.

25. The membrane of claim 22, wherein the flexible adhesive sheet is waterproof.

26. The membrane of claim 22, wherein the flexible adhesive sheet comprises a bitumen containing material.

27. The membrane of claim 22, wherein the flexible adhesive sheet comprises a rubberized material.

28. The membrane of claim 22, wherein the non-adhesive sheet member comprises a polymeric material.

29. The membrane of claim 22, wherein the sheet member comprises an elongated sheet member having length dimension greater than a width dimension.

30. The membrane of claim 24, wherein the non-adhesive sheet member is disposed over a first portion of the width of the elongated sheet member and the second portion that is free of the non-adhesive sheet member is associated with a second portion of the width of the elongated sheet member.

31. The membrane of claim 22, wherein the adhesive sheet member comprises an adhesive material integrally formed with the sheet member.

32. The membrane of claim 22, further comprising:
first and second bottom release sheets releasably attached to the bottom surface.

33. The membrane of claim 22, wherein the adhesive sheet member is free of internal reinforcement.

34. The membrane of claim 22, further comprising:
a spacer material adhered to the bottom surface of the adhesive sheet member.

35. The membrane of claim 22, wherein said non-adhesive sheet member comprises a wicking material.

36. A method for forming a sill seal on a sill surface of an opening in building structure, comprising:
disposing a flexible membrane across the length of a generally horizontal sill surface disposed between first and second upright members, wherein a first portion of the membrane disposed above the sill surface includes a facer material and a second portion of the membrane that extends beyond the sill surface is free of the facer material,
folding the second portion of the membrane transverse to the generally horizontal sill surface, wherein a bottom surface of the second portion is adhered to an outside surface of the opening.

37. The method of claim 36, wherein disposing includes placing a first end of the flexible membrane at least partially up the first upright member and a second end of the flexible membrane extends at least partially up the second upright member.

38. The method of claim 36, further comprising:
removing a bottom release sheet from the bottom surface of the flexible membrane to expose an adhesive bottom surface.

39. The method of claim 38, further comprising:
contacting the adhesive bottom surface of the first portion of the flexible membrane to the generally horizontal sill surface.

40. The method of claim 38, further comprising:
contacting the adhesive bottom surface of the second portion of the flexible membrane to the outside surface of the opening.

41. The method claim 36, further comprising:
removing a top release sheet from a top surface of the second portion of the membrane.
